(19) United States
(12) Patent Application Publication
(10) Pub. No.: US 2014/0002482 A1
(43) Pub. Date: Jan. 2, 2014

(54) FASTER RECOGNITION OF RCORDS TYPE IN TOUCH SCREEN

(71) Applicants: Nissan Ben Shitrit, Brooklyn, NY (US); Shmuel Elkeslasi, Brooklyn, NY (US)

(72) Inventors: Nissan Ben Shitrit, Brooklyn, NY (US); Shmuel Elkeslasi, Brooklyn, NY (US)

(73) Assignee: FOONCRAZY CORP, Brooklyn, NY (US)

(21) Appl. No.: 13/253,826

(22) Filed: Oct. 5, 2011

(51) Int. Cl. G09G 5/02

(52) U.S. Cl. CPC G09G 5/02
USPC 345/593

(57) ABSTRACT

Systems, methods and devices for records recognition in touch screen presented tabular records. All record-type are represented by two markers colors. These methods eliminated one tappable element and pictures that mark types of records. For example ah -application that showing records list of calls/video/text. The application is for touch screen device like Phones. The screen contains three types of records: Incoming, Outgoing, Missed and three buttons with black background. The marker is the text on the button, and the marker-colors are RGB. The buttons are placed on top/bottom of the screen. Left marker is a text “Outgoing”, with blue color. Middle marker is a text “Incoming”, with green color. Right marker is a text “Missed”, with red color. Each record contains two rows and four fields. The marker field is “time” field, and its marker-color is like the marker color of one of the markers.

### CROSS-REFERENCE TO RELATED APPLICATIONS

This patent application is related to another U.S. patent application which was filed by the inventor contemporaneously with this application. The title of the related patent application is: “Summation of tappable elements results/actions by swipe gesture”

### BACKGROUND

Most touch-screen devices have small screens therefore there is a swift and accurate control of the ringer movements. This ability allows us to invent the first registered patent utility TITLE: “Summation of tappable elements actions/results by swipe gesture”. This innovation avoids using the tappable element “All”—when tapped “show all records”. Tappable element “All” represents all records and not specific records type. Instead of tapping on this element we swipe gesture over all elements representing records type and get the same result.

Omitting tappable-element which represents all records is a base for established present patent By that we can mark with color text-field selected from the tabular record.

Other touch-screen application don't omit the “All” tappable element and use an icon/picture to mark records-type instead of marking text-field with color.

### SUMMARY

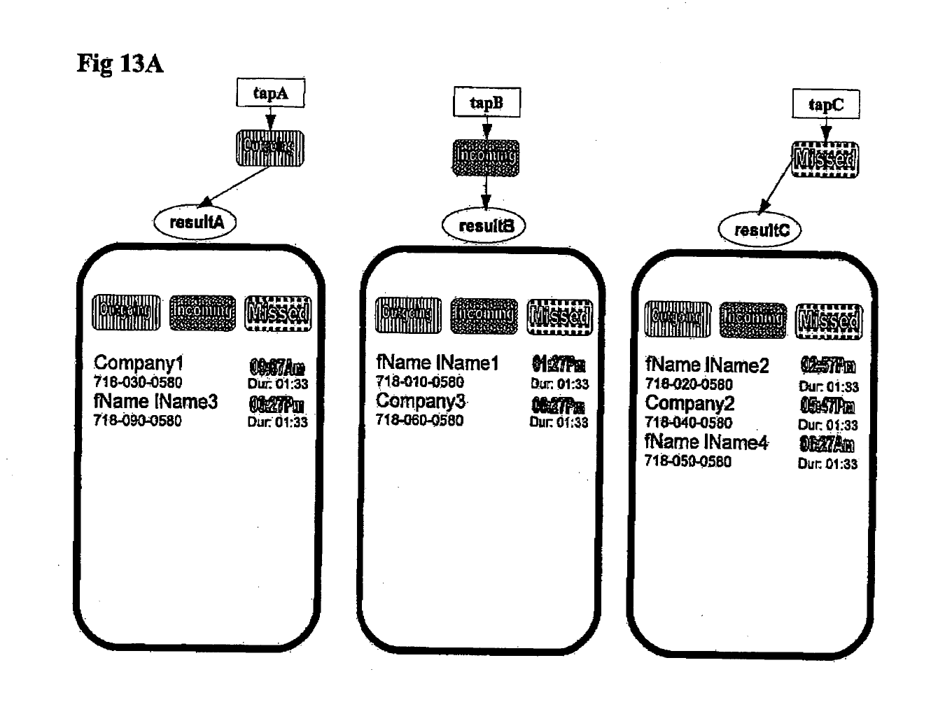

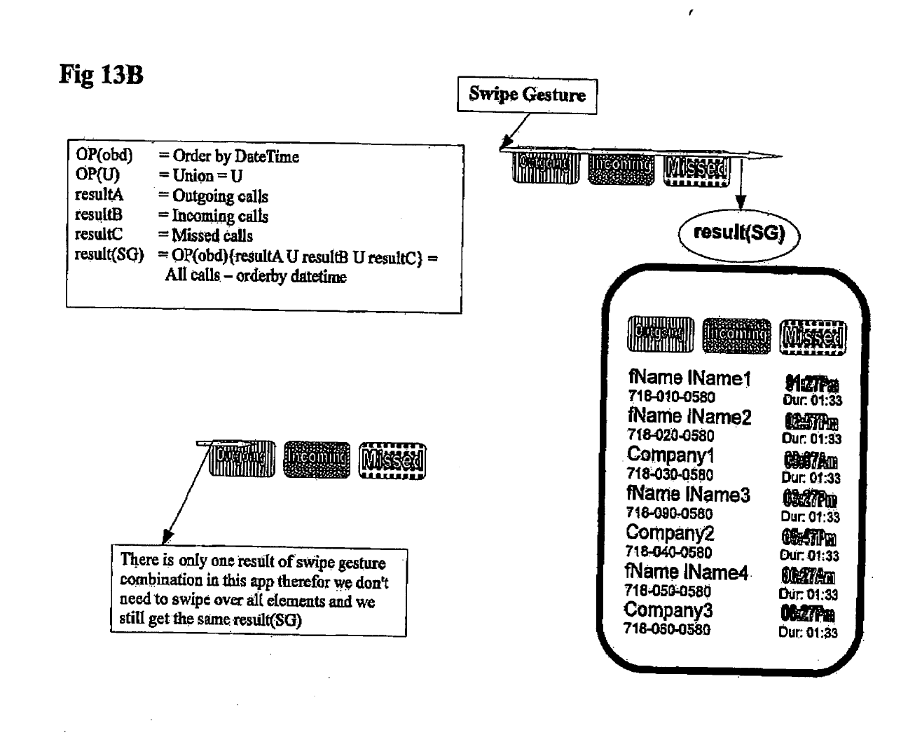

Fast recognition of records is possible in the present invention without using icons/pictures to mark the type of records. Touch screens which use icons/pictures to mark type of records overload the user's eyes with superfluous visual objects. In FIG. 13 we see on the left side of the recent-calls touch-screen, icons that are marked records-type instead of selecting text-field to be the marker.

In the present invention we omit the “All” visual tappable-elements which when tapped show all records instead we used swipe-gesture over elements to get the same results. Touch screen which uses the “All” elements overload the user eyes in superfluous visual objects. In FIG. 13 we see on right top corner the “All” tappable-element which the other application used.

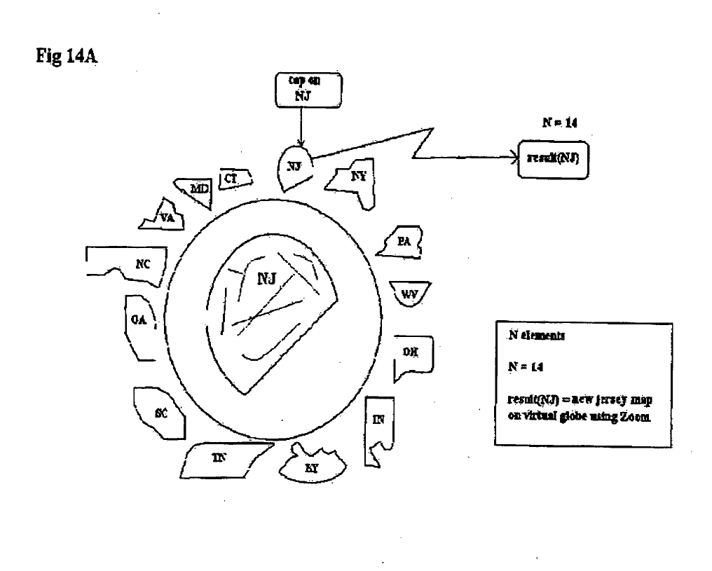

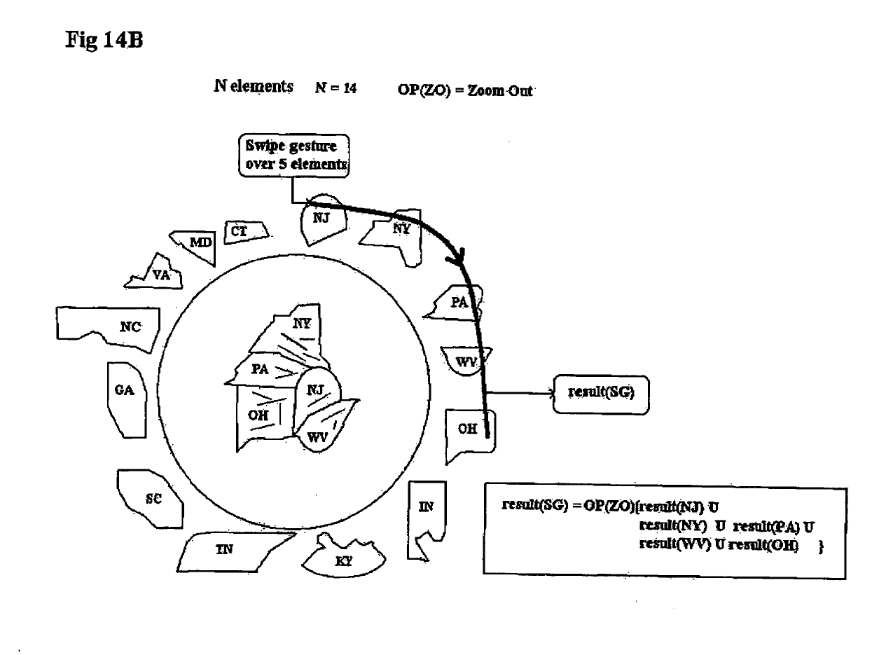

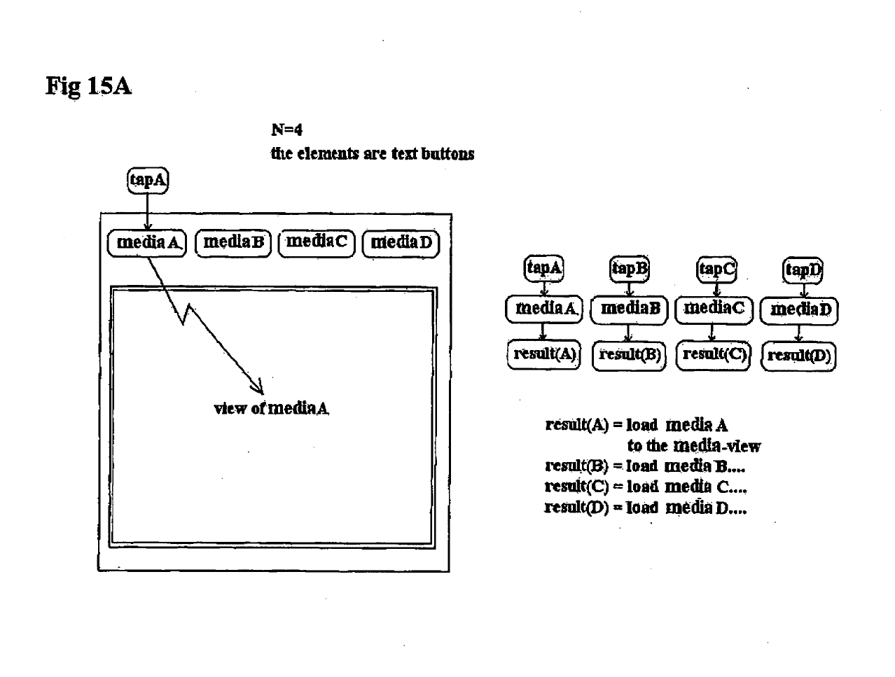

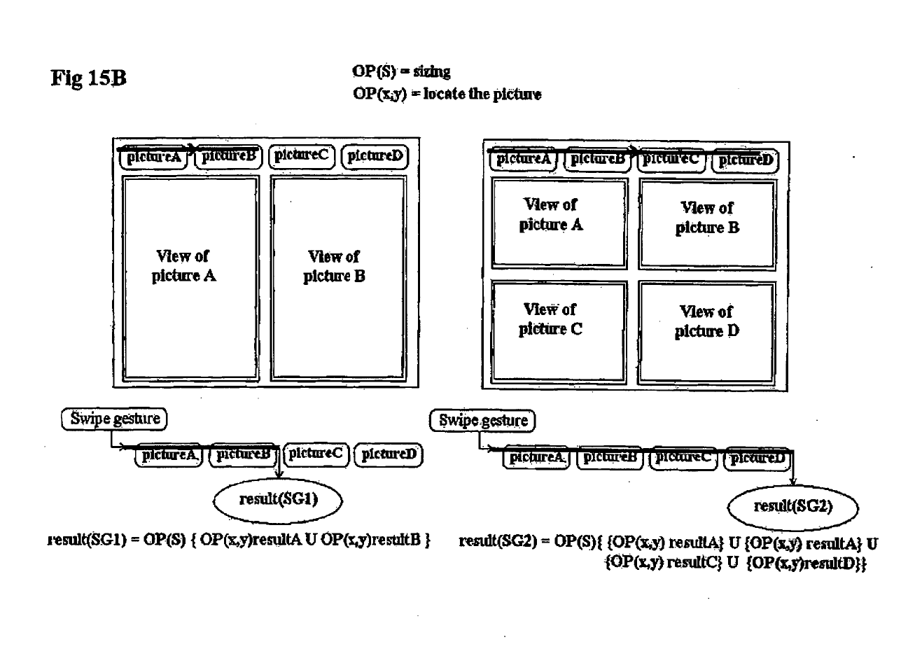

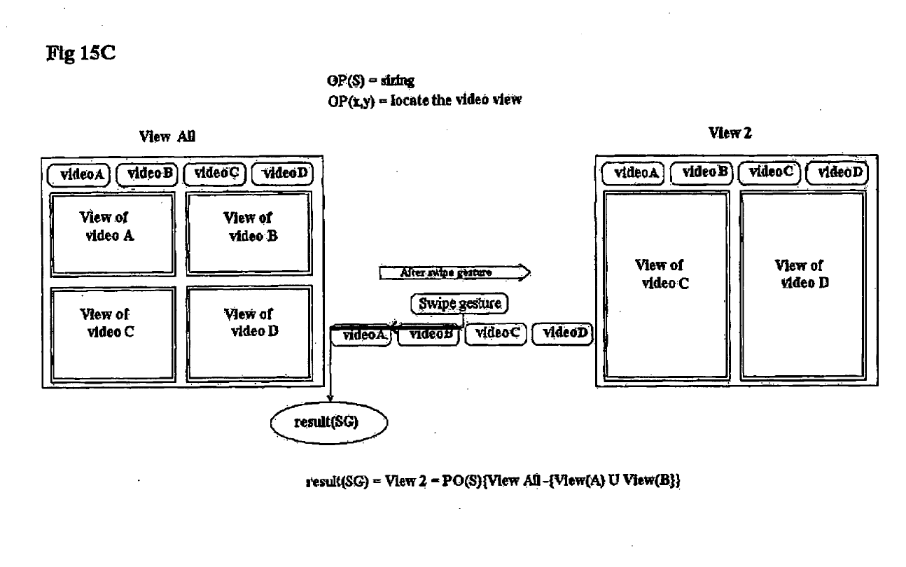

In the present invention every tappable element which when tapped shows records, contains a marker associated to the type of records. For each marker there is a marker-color represented to the type of record. FIG. 14 illustrates another application that didn't use marker color for the tappable element, which when tapped shows records.

In the present invention every records-type is represented by a unique marker-color, which is shown on the marker and also on the marker-field. FIG. 14 illustrates another application that uses only the color red in the phone-number text-field for records-type “missed calls”, but for other type the used icons of phone and arrow.

### DETAILED DESCRIPTION

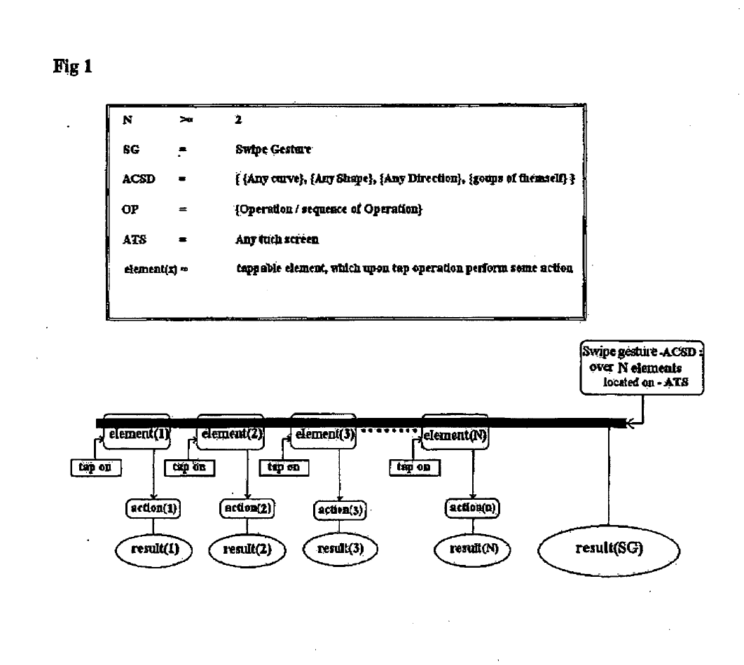

Reference is now made to FIG. 1 which depicts a touch screen. The screen includes 3 tappable elements: A, B, C. the tappable elements are picture buttons. Each of these elements contain corresponding marker. The markers are shapes of arrows and rectangle. Design includes list of records in tabular form, each record contains marker field. The marker field is the time field. Marker fields have marker-colors: A, B, C. Element marker-color is similar to the marker-color of the marker field.

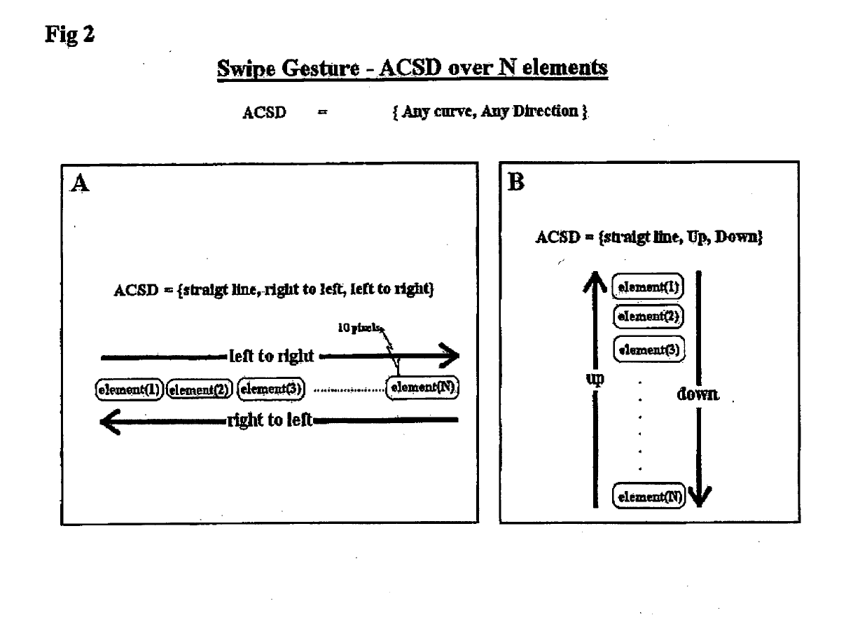

An example of the present patent can be seen with respect to FIGS. 2A-2D Each tappable elements when tapped shows the type of record that is color-marker represented the markers are shapes and one of them with contour.

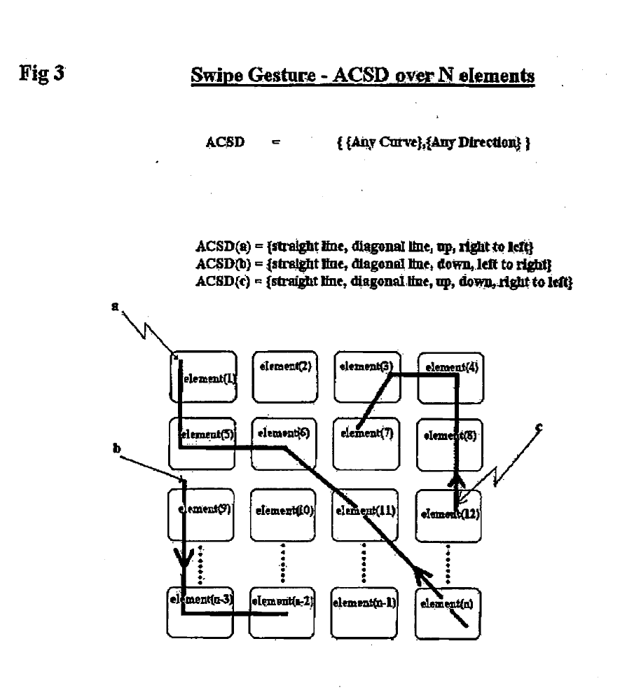

A picture marker can be seen with respect to FIG. 3.

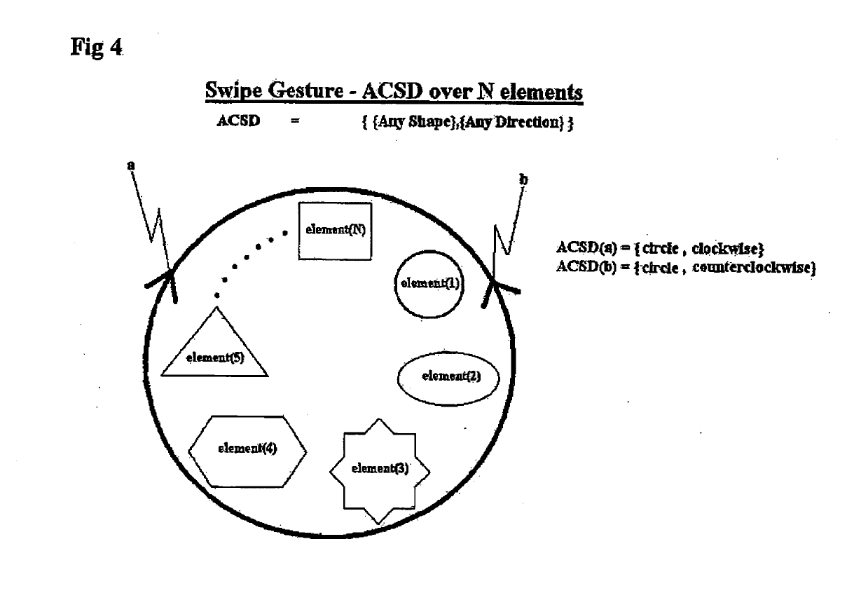

A part of pictures marker can be seen with respect to FIG. 4.

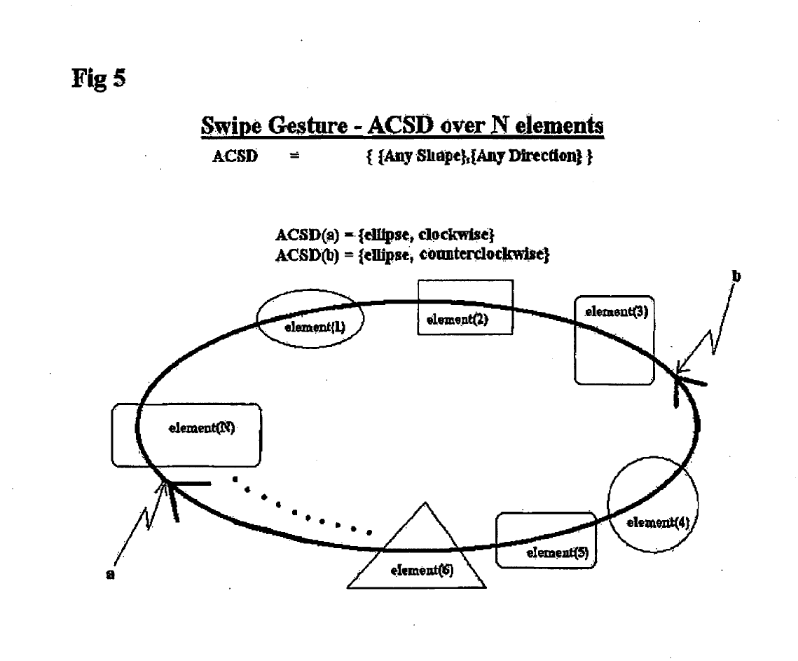

A text marker can be seen with respect to FIG. 5.

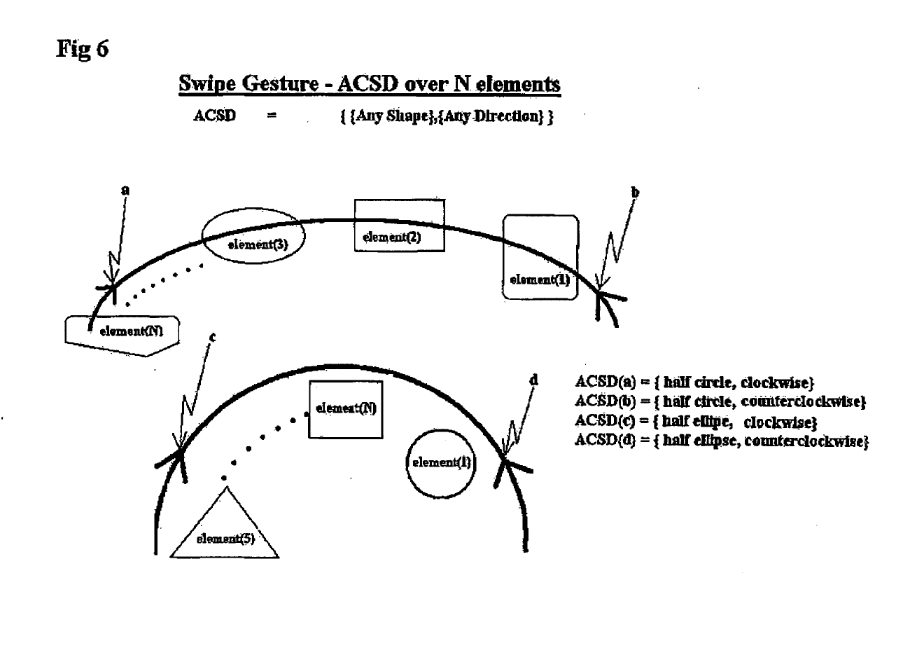

A part of text marker can be seen with respect to FIG. 6.

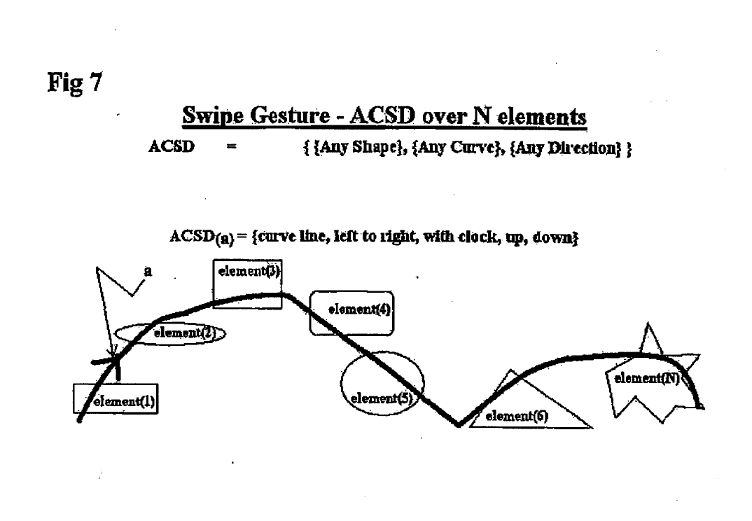

A part of the marker-field text can be seen with respect to FIG. 7.

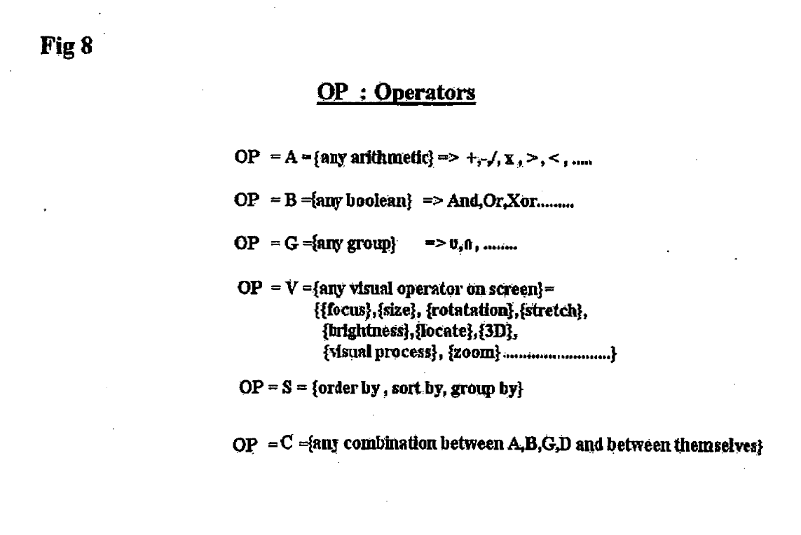

A backgrounds marker can be seen with respect to FIG. 8.

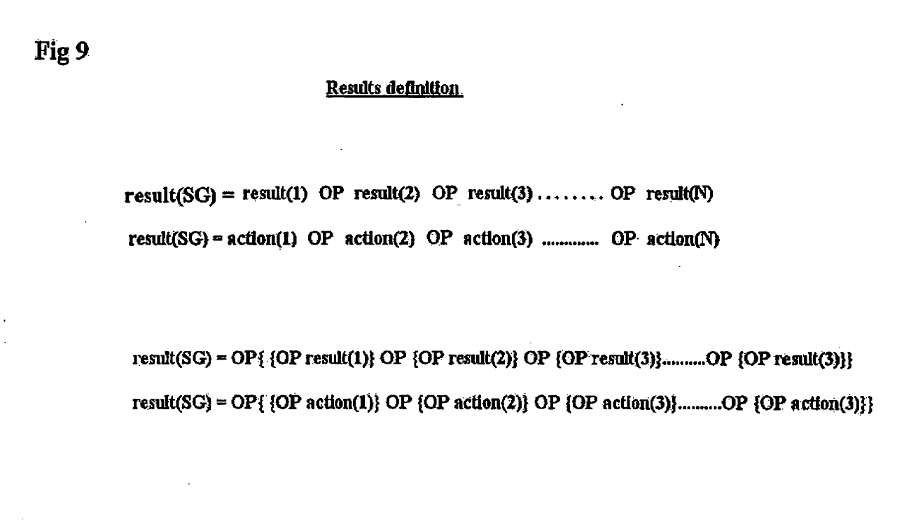

A backgrounds marker-field can be seen with respect to FIG. 9.

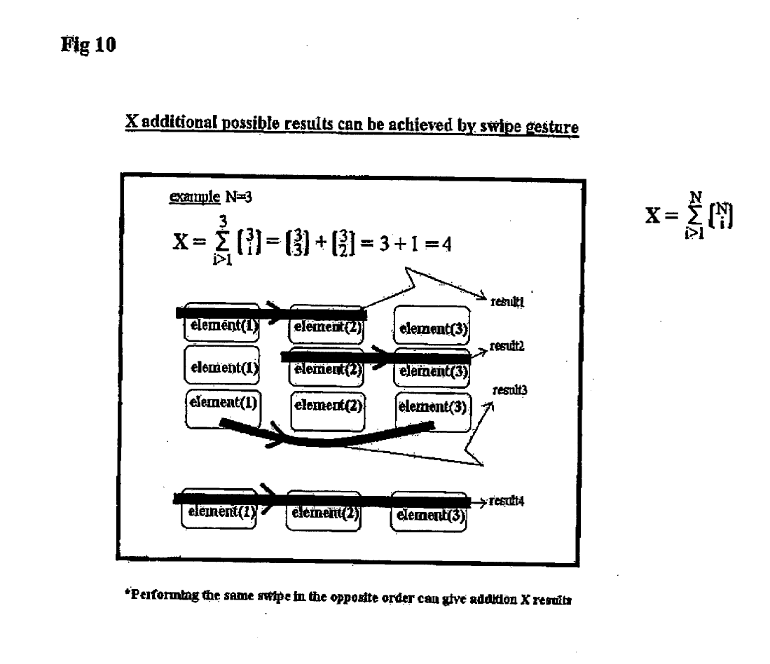

A part of backgrounds marker-field can be seen with respect to FIG. 10.

A contoured marker-field can be seen with respect to FIG. 4.

A gradient/shadow/transparency/contour effects on marker-colors can be seen with respect to FIGS. 3,4,5,8.

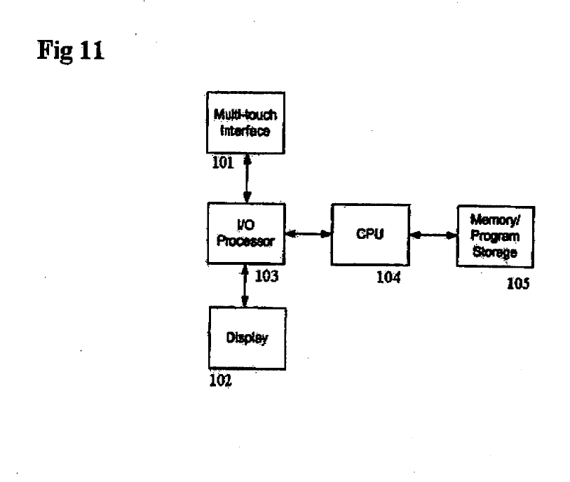

A main color and secondary colors on marker-colors of marker and marker-field can be seen with respect to FIG. 11.

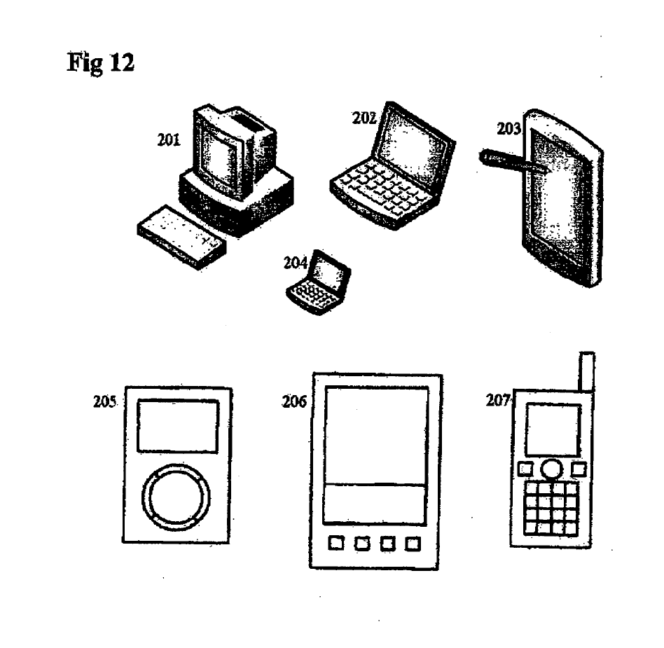

An equivalence of colors-marker can be seen with respect to FIG. 12. Equivalent A is same color but one is brighter. Equivalent B is two different colors from the same shade. Equivalent C is two different colors adjacent to each other on the color wheel.

1. A method to allow easy recognition of record type in tabular presentation form on touch screen by defining “marker” for each tappable visual element placed on the screen, which shows records when tapped. The marker is associated to record type. Each marker has unique marker-color according to represented record type. Additionally we select a field from the record fields to be the “marker-field” which also represents record type by its marker-color, Each marker-color of the “marker-field” is equivalent to the marker-color of one of the “markers”.

2. The method of claim 1 wherein the visual tappable element are on touch-screen elements each of when tapped represented records.

3. The method of claim 2 wherein the on touch-screen tappable element are selected from a group consisting of: buttons, picture-buttons, pictures, elemental picture, icons, or visual graphic objects.

4. The method of claim 1 wherein the marker can be the background of the tappable element or part of the background.

5. The method of claim 1 wherein the marker can be the text on the tappable element or part of the text.

6. The method of claim 1 wherein the marker can be visual shape on the element or part of visual shape.

7. The method of claim 1 wherein the marker can be picture on the element or part of the picture.

8. The method of claim 1 wherein the marker-color can be selected from the group of all colors.

9. The method of claim 1 wherein the marker-color can be selected from the group of gradient/shadow/transparency/contour effects.

10. The method of claim 2 wherein the tappable elements always contain marker-color which represent record type.

11. The method of claim 1 wherein the elements placed can be located at the top or bottom row, left or right column.

12. The method of claim 2 wherein the tappable elements cannot be element which shows all records when tapped.

13. The method of claim 1 wherein the marker-color can be main color and secondary colors.

14. The method of claim 1 wherein the marker-field is a text field selected from the record fields or part of text field.

15. The method of claim 14 wherein the text field can be a background, contour of the text field or part of them.

16. The method of claim 1 wherein the marker can be a combination of shape, picture, text, background.

17. The method of claim 1 wherein the marker can be lines or points or combination between them.

18. The methods of claim 1 wherein the equivalent can be same color but one is brighten. Equivalent can be from the same colors shade for example: red-tomato and red-rose and magenta or forest green and apple green. Equivalent can be two different colors adjacent to each other on the color wheel.
